(19) United States
(12) Patent Application Publication
(10) Pub. No.: US 2010/0060015 A1
(43) Pub. Date: Mar. 11, 2010

(54) PORTABLE GENERATOR HAVING A DETACHABLE PANEL

(76) Inventor: Guy T. Buker, Santa Fe Springs, CA (US)

Correspondence Address: STETINA BRUNDA GARRED & BRUCKER, 75 ENTERPRISE, SUITE 250, ALISO VIEJO, CA, 92656, US

(21) Appl. No.: 12/209,022

(22) Filed: Sep. 11, 2008

(51) Int. Cl. H02K 5/22

(52) U.S. Cl. 290/1 R

(57) ABSTRACT

A portable generator is provided with a remote power source connection, and optionally also provided with remote control and/or monitoring features. The portable generator's control panel is partially or entirely removable from the portable generator. A short pigtail with a weatherproof multi-pin connection connects to the generator's wiring harness. The multi-pin connector on the pigtail allows the panel to be removably connected to the pigtail and the generator to be removably connected to an interconnecting cord. A longer interconnecting cord connects the removable panel to the generator, and transmits the power to the remotely locatable panel, along with transmitting any desired control aspects such as on, off, start, or circuit breaker re-set commands, and/or transmitting any desired monitoring information such as voltage, amperage, gas level, oil level, frequency of the generated power, circuit breakers, or operating time. But preferably the removable panel has all the power outlets supplied by all the electrical power generated by the portable generator.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field of the Invention

The present invention relates to a portable generator and, more particularly, a portable generator having a detachable panel configured to operate when the panel is detached from the portable generator.

2. Description of the Related Art

Electrical generators are used to convert mechanical energy into electrical energy. Generators are very well known and used in a variety of contexts. For example, a generator can be used as a secondary or back-up power source for a building or as the primary power source at a construction site. Numerous other situations or uses for a generator are possible. One type of well known generator is the portable generator. The portable generator may be used at construction cites where mobility is important, another use may include camping wherein the portable generator may be used as a power source for a motor home or a recreational vehicle. Electrical generators typically include an armature. The armature is a power producing component of an alternator, generator, dynamo or motor associated with the electrical generator. The armature windings generate the electrical current. The power produced by the electrical generator is used to provide power to a device connected to the electrical generator.

Portable generators provide a source of power through electrical connections. The portable generator includes a panel that may include various control features such as an electric start, an off switch, an on switch, or circuit breakers and breaker interrupt or reset switches. The panel may also include various monitoring devices, such as displays for voltmeters, ammeters, fuel low indicators, oil low indicators, generated frequency and hours operated. Additionally, the panel may include a plurality of power outlets, each outlet being configured to receive a plug, often plugs of various configurations and of various voltages. For example a device to be powered by the portable generator is plugged into one of the outlets to receive power from the portable generator. The use of portable generators may be limited or inhibited due to natural elements such as rain, snow or flooding. In most instances the portable generator is located outside while providing a source of power to a device or devices, some of which may be indoors. Therefore, if the user of the portable generator would like to change the controls or connect another or different device to the portable generator, the user must go outdoor to change a setting or connection corresponding to the portable generator.

The panel used to control the portable generator or provide power connections is sensitive to environmental dangers, particularly rain or other forms of moisture that can cause electrical shorts. Furthermore, if the generator is to be controlled or turned off, or switch connections, the user of the portable generator must leave the residence, recreational vehicle, or motor home for example and face the environmental elements to fiddle with the controls of the portable generator, disconnect a plug, or turn the generator off. To prevent having to brave certain environmental elements, some users move the portable generator indoors for convenience or to protect the generator from various environmental elements. But, the use of portable generator indoors is dangerous and may cause death from the exhaust of the engine powering the generator. As a result, bringing the portable generator within a building or other enclosed structure is strongly discouraged. Additionally, the portable generator emits noise, heat, and other pollutants that make it unsuitable for use indoors or in crowded areas. Thus, for safety reasons the portable generator should operate outdoors. Therefore, the problem of having to control the generator and connect devices to the generator at the portable generator co-exists with the restrictions on the location and use of the generator.

A well known method used to connect devices to be powered by the portable generator from a location away from the portable generator includes the use of an extension cord. For example, the extension cord may be connected to the portable generator and is sufficiently long enough to provide a connection for a device at a desired distance away from the portable generator. The extension cord may be plugged into an outlet of the portable generator and allowed to run from the area where the portable generator is located to the indoor location of a residence or home. This allows the user of the portable generator to plug a device via the extension cord to the portable generator without requiring the portable generator to be placed inside the residence where it presents a safety hazard and other undesired qualities such as noise. Although the use of an extension cord allows for a device to be connected to the portable generator at a certain distance, there remain several problems that the use of the extension cord does not solve. The extension cord does include a plurality of outlets configured to accept various types of plugs. Additionally, the portable generator cannot be controlled or monitored via the extension cord. If a user would like to turn the portable generator on or off, the user must do this at the portable generator. Furthermore, the extension cord does not shield sensitive areas associated with the portable generator including the panel itself from severe environmental conditions such as driving rain.

Accordingly, there exists a need in the art for an improved portable generator which addresses one or more of the above or related deficiencies.

### BRIEF SUMMARY

A portable generator is provided with a remote power source connection, and optionally also provided with remote control and/or monitoring features. The portable generator's control panel is partially or entirely removable from the portable generator. A short pigtail with a weatherproof multi-pin connection connects to the generator's wiring harness. The multi-pin connector on the pigtail allows the panel to be removably connected to the pigtail and the generator to be removably connected to an interconnecting cord. A longer interconnecting cord connects the removable panel to the generator, and transmits the power to the remotely locatable panel, along with transmitting any desired control aspects such as on, off, start, or circuit breaker re-set commands, and/or transmitting any desired monitoring information such as voltage, amperage, gas level, oil level, frequency of the generated power, circuit breakers, or operating time. These control or monitoring aspects advantageously appear only on one panel located on either the portable generator or the remote panel so that when the removable panel is fastened to the generator there is no redundancy. Various combinations of the control functions, monitoring displays and electrical outlets could be located on either the generator or the remote panel. But preferably the removable panel has all the power outlets supplied by all the electrical power generated by the portable generator.

The removable panel advantageously takes the form of a weatherproof enclosure with a multi-pin connector on the back of the panel to electrically couple with a mating connector on the generator for direct connection to the generator and use with the portable generator. The removable panel may snap into place or otherwise releasably lock into a mating recess on the generator configured to receive the panel. A weather shield advantageously protects any water-sensitive displays, switches or outlets from exposure to driving rain when the removable panel is on the generator, although the rain shield preferably remains attached to the generator when the panel is removed. By unplugging the multi-pin connector from the connection on the pigtail connected to the generator wiring harness, and by inserting an interconnecting cord between the generator and removable panel, the removable panel can be placed indoors or at another location remote from the generator. The interconnecting cord can be of various lengths to accommodate various applications and needs. If command or monitoring information is transmitted through the interconnecting cord then appropriate shielding should be applied as needed to prevent the electricity in the power transmission wires from interfering with the signals in the command or monitoring wires.

For example, a nine pin connector may be used to transmit 120 volts through a single wire connected to a single pin, with wires from one pin powering a 120 volt outlet, and wires from two pins connected to power a 220 volt outlet. In addition to being connected to at least one live wire, an outlet also connects to a neutral wire and a ground wire, so the transmission cable contains four wires in addition to whatever wires are required for control and monitoring. Those electrical power wires are advantageously shielded from the wires transmitting the control information so as to avoid electromagnetic interference and any other signal distortion. The various wires in the transmission cable are connected to suitable wiring in the removable panel to correctly distribute the power, and the transmitted signals associated with the control and monitoring of the generator. Advantageously, the remote panel contains at least one electrical power outlet and a wire for at least one circuit breaker and reset. Preferably the remote panel receives transmitted information on various parameters relating to the operation and health of the generator.

In more detail, the portable generator includes a first electrical connector electrically connected to a current source of the portable generator. The current source may include the windings disposed within the portable generator or electrical circuitry coupled to the windings. The first electrical connector transmits the current from the current source to a circuit that is coupled to the first electrical connector such as a control panel or power panel. The electrical connector preferably provides an electrical circuit path from the portable generator to the power source connection. The portable generator also includes a detachable power panel. The detachable power panel has a second electrical connector. The second electrical connector is configured to receive the first electrical connector. The second electrical connector is configured to receive the first electrical connector when the detachable power panel is coupled to the portable generator. In other words, the detachable power panel is plugged into the first electrical connector of the portable generator. In other words, the detachable power panel is plugged into the first electrical connector of the portable generator via the second electrical connector of the detachable power panel. The detachable power panel is also configured to receive current from the portable generator when the detachable power panel is detached or removed from the portable generator. When the detachable power panel is detached from the portable generator, an interconnecting cord may be used to connect the portable generator and the detachable power panel. The interconnecting cord is connected to the first electrical connector and the second electrical connector. As a result, the portable generator and the detachable power panel are electrically connected via the interconnecting cord.

The detachable power panel includes a plurality of power outlets. Each power outlet is configured to receive a power plug for an electrical device. When the power plug is plugged into the power outlet, electric power flow is provided from the portable generator to the device that is plugged into the detachable power panel. Therefore, a remote power source connection for the portable generator may be provided when the detachable power panel is detached from the portable generated and connected to the first electrical connector via the interconnecting cord and the second electrical connector.

In another embodiment of the present invention, the first electrical connector is a cable. The cable has a first and a second opposing end. The first end of the cable is configured to receive current generated by the portable generator. The second end of the cable includes a connector for receiving the interconnecting cord. Upon receipt of the interconnecting cord, the portable generator may transmit current to the detachable power panel via the interconnecting cord. The detachable power panel may also include an electrical circuit for regulating the current received from the portable generator. Furthermore, the portable generator may include a weather shield adjacent to the area where the detachable power panel is coupled to the portable generator. The weather shield protects sensitive parts associated with the portable generator when the detachable power panel is detached from the portable generator.

In another embodiment, the portable generator also includes a support member. The support member is used to securely couple the detachable power panel to the portable generator. The support member may include a hinge and a spring loaded latch for removing or affixing the detachable power panel to the portable generator. In yet another embodiment, the support member may include a recessed cavity. The recessed cavity is configured to receive and secure the detachable power panel. The second electrical connector of the detachable power panel is received by the first electrical connector of the portable generator when the detachable power panel is securely coupled to the portable generator. Therefore, the interconnecting cord is not necessary and may be stored for future use when the detachable power panel is detached from the portable generator.

When the detachable power panel is detached from the portable generator a retractable leg may be utilized to provide support. The retractable leg is pivotally attached to the detachable power panel. When the detachable power panel is detached or removed from the portable generator, the retractable leg may pivot outwardly and provide balance and support so that the detachable power panel is free standing. Alternatively, when the detachable power panel is coupled to the portable generator, the retractable leg is pivoted against the removable panel to allow for secure coupling of the detachable power panel to the portable generator. The ability to stow away the retractable leg when securely coupling the detachable power panel to the portable generator is that the leg does not interfere with the coupling onto the portable generator. In an alternate embodiment, the detachable power panel is enclosed or confined within a freestanding compartment. The freestanding compartment is configured to attach to or detach from the portable generator. The freestanding compartment is configured to stand in a balanced position when the detachable power panel is detached from the portable generator. Additionally, the freestanding compartment includes adequate storage space for storing the interconnecting cord used to connect the first electrical connector of the portable generator to the second electrical connector of the detachable power panel.

In another embodiment, a portable generator having a detachable panel is provided. The portable generator includes a first electrical connector electrically connected to a current source associated with the portable generator. The first electrical connector is configured to transmit current generated by the portable generator to a circuit coupled to the first electrical connector. The portable generator also includes a detachable control panel. The detachable control panel includes a second electrical connector. The second electrical connector may be plugged into the first electrical connector when the detachable control panel is coupled to the portable generator. The detachable control panel is also configured to receive current from the portable generator when the detachable control panel is detached from the portable generator. This may be accomplished using an interconnecting cord that links the first electrical connector of the portable generator with the second electrical connector of the detachable control panel. In other words, the interconnecting cord may act as a conduit for the electrical circuit path from the portable generator to the detachable control panel. The detachable control panel includes a plurality of generator controls. Each generator control may be used to regulate the output of the portable generator. For example, voltage, frequency, and other generator controls may be regulated using the detachable control panel. Additionally, the detachable control panel may include a timer for regulating the time the portable generator operates. Further, the detachable control panel may include and electric start switch for powering on or off the portable generator. The detachable control panel may also include a display for viewing the plurality of generator controls and current settings. The detachable control panel includes a circuit breaker and reset switch.

The first electrical connector may comprise a cable. The cable includes a first and a second opposing end. The first end of the cable is configured to receive the current generated by the portable generator. The second end of the cable includes a connector. The connector is configured to receive either the interconnecting cord or the second electrical connector corresponding to the detachable control panel. The current generated by the portable generator may be transmitted through the interconnecting cord or the second electrical connector to the detachable control panel. The detachable control panel includes an electrical circuit for regulating the current received from the portable generator.

In yet another embodiment, a portable generator having a detachable panel is provided. The detachable panel includes a power source connection for remote connection to the portable generator when the detachable panel is detached from the portable generator. Additionally, the detachable panel provides remote generator control functions when it is detached from the portable generator. The portable generator includes a first electrical connector electrically connected to a current source associated with the portable generator. The first electrical connector provides a circuit path for transmitting current to a circuit coupled to the first electrical connector. The portable generator also includes a detachable panel having a second electrical connector. The second electrical connector is configured to receive the first electrical connector when the detachable panel is coupled to the portable generator. The detachable panel is also configured to receive current generated by the portable generator when the detachable panel is detached from the portable generator. An interconnecting cord is used to link the first electrical connector of the portable generator to the second electrical connector of the detachable control panel. The current generated by the portable generator may be transmitted to the detachable panel via the interconnecting cord. The detachable panel includes a plurality of outlets for providing a remote power source connection when the detachable panel is detached from the portable generator. The detachable panel also includes a plurality of generator controls. Each generator control is configured to regulate the output or operation of the portable generator. Thus, the detachable panel provides both remote power source connections and the ability to affect the operation of the portable generator remotely.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a portable generator with a panel detached from the portable generator;

FIG. 2 is a perspective view of the portable generator, depicting a first electrical connector of the portable generator;

FIG. 3a is a side view of the portable generator with a detachable power panel coupled to the portable generator;

FIG. 3b is a side view of the portable generator with a detachable control panel coupled to the portable generator;

FIG. 4 is a side view of the portable generator with a detachable panel coupled to the portable generator, the panel including power and control functions;

FIG. 5 is a perspective view of the detachable panel shown in FIG. 1 detached from the portable generator;

FIG. 6 is a rear view of the detachable panel of FIG. 5 depicting a second electrical connector;

FIG. 7 is a perspective view of a portion of the portable generator with an interconnecting cord coiled on a rack; and

FIG. 8 is a perspective view of an interconnecting cord connected to a first connector of the portable generator and a second connector of the detachable panel.

FIG. 9 is a perspective view of the portable generator of FIG. 7 with a weather shield.

### DETAILED DESCRIPTION

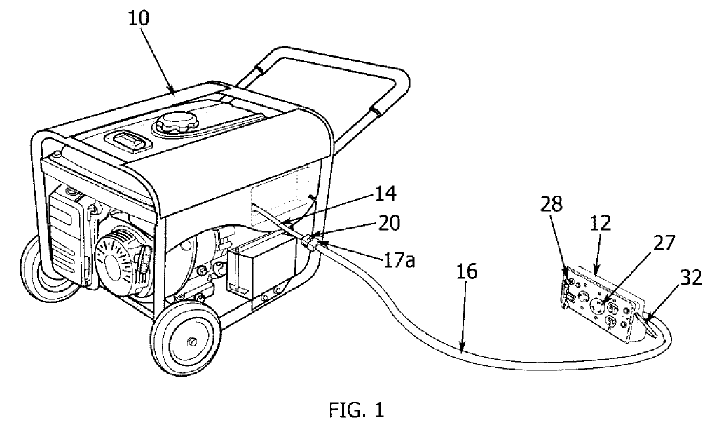

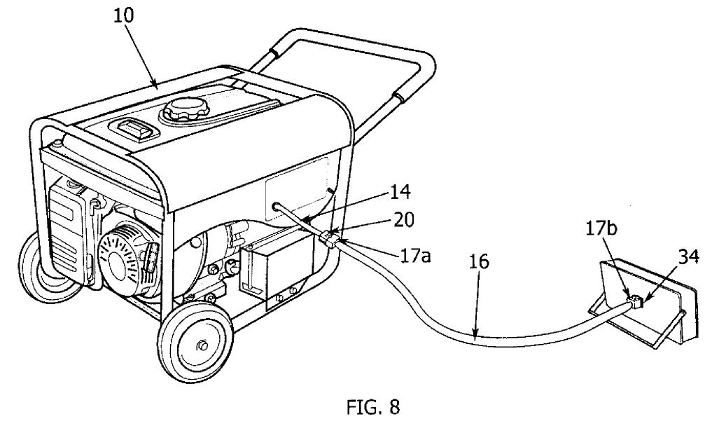

With reference to FIGS. 1 and 8, a portable generator 10 having a detachable panel 12 is provided. The detachable panel 12 may be optionally configured to provide both a remote power source connection and the ability to control the portable generator 10 remotely. As used herein, the term “generator” means an apparatus or system that converts mechanical power from an internal combustion engine into electric power or energy. There are many well known embodiments of a portable generator. One such embodiment may include an alternator with a rotor coupled via a shaft to an internal combustion engine. The rotor may include magnets that interact with one or more windings of a stator when the engine causes the rotor to rotate. The interaction of the magnets with the winding(s) results in a current produced in the windings. The above configuration of a portable generator is by way of example only and not of limitation. The detachable panel 12 provided may be used with any of these various types of generators.

Briefly summarized, the generator 10 has a detachable panel 12 connecting the electrical power of the generator to a removable or detachable control panel 12. The control panel 12 may have various combinations of electrical outlets, control switches and monitors, with some portion of outlets, control switches and monitors also remaining on the generator 10, although preferably most or all outlets, controls and monitors are on the detachable control panel 12. A short pigtail cable 14 with a multi-pin connector 20 mates with a corresponding multi-pin plug or connector 34 on the panel 12 to place the panel 12 in electrical communication with the generator 10 when the panel is on the generator. An interconnecting cable 16 with connectors 17a, 17b on opposing ends of the cable 16 is interposed between the connectors 20, 34 when the panel is located remote from the generator. In addition to transmitting power for at least one electrical outlet on the panel 12, the pigtail 14 and interconnecting cord 16 transmits various combinations of control and monitoring signals to the panel 12, with the depicted embodiment showing all generator outlets 27, controls 28 and displays 29 on the detachable panel 12. The interconnecting cord 16 may optionally be coiled and placed on a holding hook or rack on the generator.

In more detail and referring to the embodiment of FIG. 1, the portable generator 10 is configured to operate when the detachable panel 12 is coupled to the portable generator 10. Alternatively, the portable generator 10 is also configured to operate when the detachable panel 12 is detached from the portable generator 10 as shown in FIG. 1. When the detachable panel 12 is detached from the portable generator 10, an interconnecting cord 16 may be used to link the portable generator 10 to the detachable panel 12. The interconnecting cord 16 is preferably rugged and configured to be weatherproof, thereby insuring an electrical circuit path between the portable generator 10 and the detachable panel 12 during harsh environmental conditions such as driving rain. The portable generator 12 also includes a first electrical connector 14 that may be used to transmit the current generated by the windings of the portable generator 10.

The portable generator 10 may include a circuit electrically connected to the windings to receive the current from the windings. The circuit may then be coupled to the first electrical connector 14. The ability to detach the detachable panel 12 from the portable generator 10 while maintaining the electrical connection via the first electrical connector 14 and the interconnecting cord 16 provides a more flexible use of the portable generator 10. The detachable panel 12 may be operated at a remote distance from the portable generator 10. The distance may depend upon the length of the interconnecting cord 16. The interconnecting cord 16 may vary in length, and has a first end with a multi-pin connector adapted to electrically connect to the multi-pin connector of the generator and an opposing end adapted to connect to the multi-pin connector of the panel 12. The ability to extend the use of the portable generator 10 using the interconnecting cord 16 and the detachable panel 12 allows for the portable generator 10 to remain in a well ventilated area while the detachable panel 12 may be brought indoors.

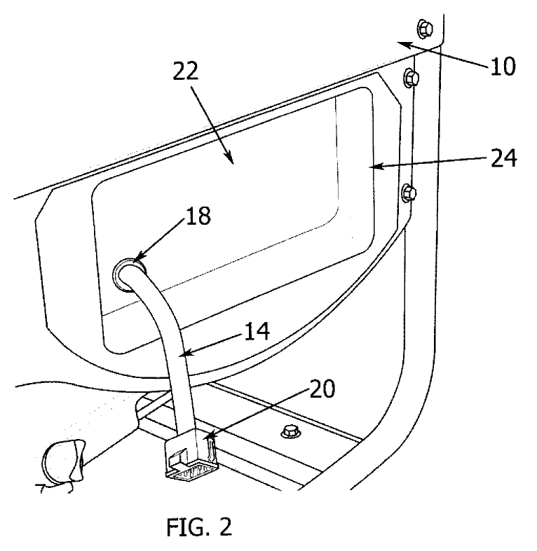

Referring now to FIG. 2, the first electrical connector 14 is a cable having a first and a second opposing end. The first opposing end (not shown) may be coupled to the windings that provide the current or to the circuit that receives the current from the windings. The first electrical connector 14 extends from the first opposing end through an aperture 18 within a protective shield 22. The aperture 18 is configured to receive the cable comprising the first electrical connector 14 such that air gaps between the aperture and the first electrical connector 14 are minimized. The second opposing end of the first electrical connector 14 is a connector 20. The second opposing end 20 may include a female or male connector. Because these multi-pin connectors have mating male and female portions, a reference herein to an electrical signal from one of the pins of these multi-pin connectors refers to either the male pin or the corresponding female socket. The connectors are a multi-pin quick connect configuration, and these connectors are sufficiently waterproof that a driving rain does not penetrate the connector and cause an electrical short. One such multi-pin configuration may include 9 pins where each pin is rated up to 120 volts. The various connectors 20, 17a, 17b and 34 are mating, multi-pin plugs or connectors.

The second opposing end 20 is configured to receive the interconnecting cord 16 for establishing an electrical connection between the portable generator 10 and the detachable panel 12 when detached from the portable generator 10. The multi-pin quick connect configuration of the connector 20 allows for quick connection or disconnect to either the interconnecting cord 16 or the detachable panel 12 depending upon whether the detachable panel 12 is coupled to or detached from the portable generator 10. The connector 20 is a weather proof connector and protects the connection from water penetration that would short out the connection.

The connector 20 is configured to receive a second electrical connector. The second electrical connector is coupled to the detachable panel 12 and may be in the form of a female connector or a male connector, depending on the nature of the connector 20. The second electrical connector is configured to connect to the interconnecting cord 16 or the first electrical connector 14 depending upon the detachable panel 12 either being coupled to or detached from the portable generator 10. In this regard, the detachable panel 12 may be connected directly to the first electrical connector 14 or indirectly via the interconnecting cord 16.

The cable comprising the first electrical connector 14 may also be variable in length. For example, in the scenario where the detachable panel 12 is coupled to the portable generator 10, it is preferable that the connector of the second opposing end 20 of the first electrical connector 14 is flush with the aperture 18. In this embodiment, the cable comprising the first electrical connector 14 is retractable through the aperture 18. This may prevent the cable from becoming tangled and interfering with the coupling of the detachable panel 12 to the portable generator 10. Alternatively, the first electrical connector 14 may extend a limited distance from the aperture 18. In one embodiment, the first electrical connector 14 may extend 8 to 12 inches from the aperture 18. Limiting the first electrical connector 14 to a length between 8 to 12 inches prevents storage issues associated with the cable comprising the first electrical connector 14. However, if the length of the first electrical connector 14 is shorter than 8 inches it could be difficult to connect the connector 20 to the interconnecting cord 16 or to the detachable panel 12.

Still referring to FIG. 2, the portable generator 10 provides the protective shield 22 mentioned briefly above. The protective shield 22 is a sheet of material preferably configured to receive the removable panel 12. The shield 22 is used to protect sensitive parts of the portable generator 10 from debris, dirt, and rain for example. When the detachable panel 12 is coupled to the portable generator 10, the protective shield 22 is not used because the detachable panel 12 provides a barrier between various environmental elements and the sensitive parts associated with the portable generator 10. Unfortunately, if the detachable panel 12 is exposed to harsh environmental conditions such as rain, a malfunction associated with the portable generator 10 may arise because of the electrical circuitry disposed within the detachable panel 12 can short out or malfunction. Therefore, it is preferable to operate the portable generator 10 during harsh environmental conditions with the detachable panel 12 detached and preferably located in an area that is not exposed to the harsh environmental conditions. Portions of the generator 10 sensitive to moisture are thus located to shield them from water, are waterproofed, or both. Thus, the protective shield 22 may be fastened to the frame of the generator and configured to prevent sensitive parts of the portable generator 10 from being exposed to the harsh environmental conditions when the detachable panel 12 is detached from the portable generator 10. The portable generator 10 may operate under strenuous conditions when the detachable panel 12 is detached and located in a protected area while the generator 10 remains exposed to the ambient temperature. For example, the portable generator 10 is advantageously configured to operate with rain falling at a 45 degree angle due to wind conditions.

The portable generator 10 may also include a recessed cavity 24 for supporting the detachable panel 12 when coupled to the portable generator 10. The recessed cavity 24 is designed to securely couple the detachable panel 12 to the portable generator 10. The portable generator 10 may include a support member instead of a recessed cavity 24 for securely coupling the detachable panel 12 to the portable generator 10. The support member may include a hinge and a spring loaded latch. The hinge and spring loaded latch provide for easy coupling and decoupling of the detachable panel 12 to the portable generator 10.

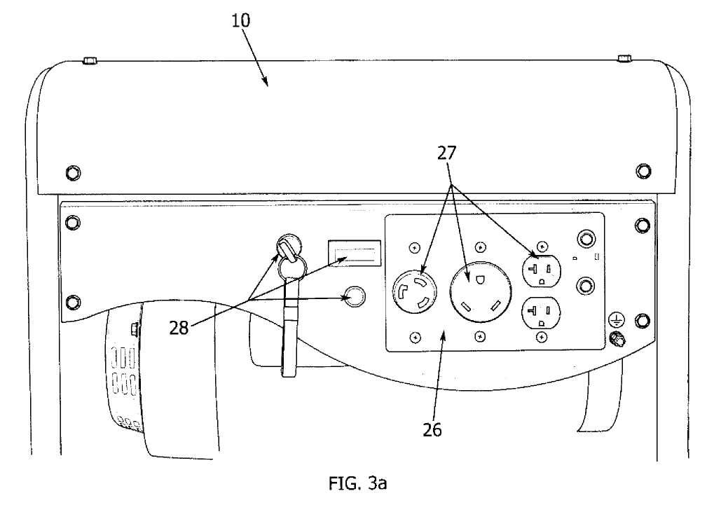

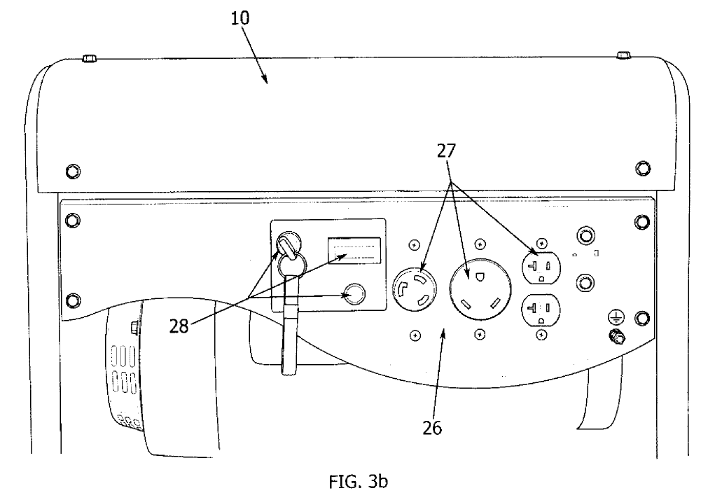

Referring now to FIG. 3a, the detachable panel provided is a detachable power panel 26. The detachable power panel 26 is shown coupled to the portable generator 10. However, the detachable power panel 26 may also be detached from the portable generator 10. The detachable power panel 26 may include electrical circuitry disposed therein for regulating the received current from the portable generator 10 to a desired voltage and frequency or that the circuitry may remain with the generator 10 when the panel 26 is detached. When the detachable power panel 26 is coupled to the portable generator 10 as provided, the power source connection is provided at the portable generator 10. A plurality of outlets 27 provides the power source connection. The plurality of outlets 27 are contact devices, intended for the mechanical or electrical connection of a plug. Therefore, when the detachable power panel 26 is detached from the portable generator 10, the plurality of outlets 27 provides a remote power source connection to the portable generator 10. Thus, a device may be plugged into the detachable power panel 26 instead of the portable generator.

Furthermore, the detachable power panel 26 may incorporate various gauges or displays 29. The detachable power panel 26 may include a variety of outlet 27 combinations. A few types of outlets by way of example include: 12 Volt (V) DC, 10 Amp (A) Outlets, 120 V AC, 15 A Outlets, 120 V AC, 30 A Locking Outlets, 120/240 V AC, 30 A Locking Outlets. The 120 V AC, 30 A Locking Outlets may use a National Electrical Manufacturer's Association (NEMA) L5-30 plug with this particular outlet. The plug may be connected with a 3-wire cord set rated for 125 Volts AC at 30 Amps. The 120/240 Volt AC, 30 A Locking Outlet may use a NEMA L14-30 plug with this particular outlet. The plug may be connected with a 4-wire cord set rated for 250 Volt AC loads at 30 Amps (or greater). Other NEMA standard plugs contemplated may include 5-20 (5 gauge, 20 A), L5-20, L5-30, L14-30, and L14-20. The plurality of outlets 27 may include a ground fault circuit interrupter (GFCI) to detect current leaking to ground and interrupt the circuit. In this embodiment the portable generator 10 does not incorporate a plurality of generator controls into the detachable power panel 26. The generator controls 28 in this embodiment are located at the portable generator 10. For example, if the user would like to turn the portable generator 10 off it still must be turned off at the portable generator 10. However, the detachable power panel 26 provides the capability of remote power source connection to the portable generator 10.

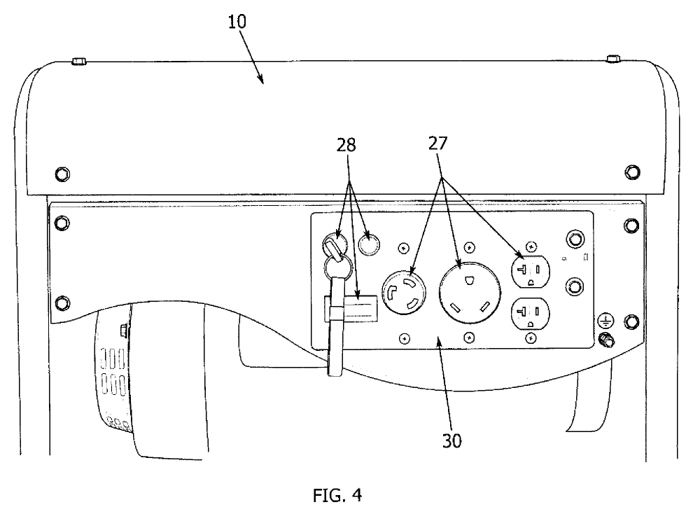

Referring now to FIG. 4, the portable generator 10 is provided with a detachable panel 30 incorporating both the plurality of outlets 27 and the plurality of generator controls 28. Similar to the detachable power panel 26, the detachable panel 30 may include electrical circuitry for regulating the current received from the portable generator 10. The detachable panel 30 is configured to have a plurality of outlets 27 and gauges similar to the detachable power panel 26 described above. Additionally, the detachable panel 30 includes the plurality of generator controls 28. The plurality of generator controls 28 may include: fuses, electric start, on or off switches, idle control switches, and circuit breakers with optional but preferred reset switches. The displays 29 or indicators may include such things as an ammeter, voltmeter, hour meter, Hertz meter, fuel level low indicators or low oil level indicators. The above described generator controls 28 and displays 29 are by way of example only and not limitation.

The detachable panel 30 is capable of being detached from the portable generator 10. Therefore, the detachable panel 30 is configured to provide a remote power source connection by plugging a device into one of the outlets 27. Additionally, because the detachable panel 30 includes various control functions, the portable generator 10 may be controlled remotely. For example, a user may turn the portable generator 10 on or off from the comfort of their own home provided that the detachable panel 30 is connected to the first electrical connector 14 via the interconnecting cord 16. This feature allows the user to activate the plurality of generator controls 28 without having to go to the power source (i.e. the portable generator 10). Some of the outlets 27 may be included on the portable generator 10 in addition to the plurality of outlets 27 located on the detachable power panel 26 or the detachable control panel 30.

Referring to FIG. 3b, the portable generator 10 may also include a detachable control panel including only control features. There are one or more outlets 27 on the portable generator 10 rather than on the detachable control panel. In this embodiment, the portable generator 10 does not provide a remote power source connection. However, the portable generator 10 may be controlled remotely using the detachable control panel 12.

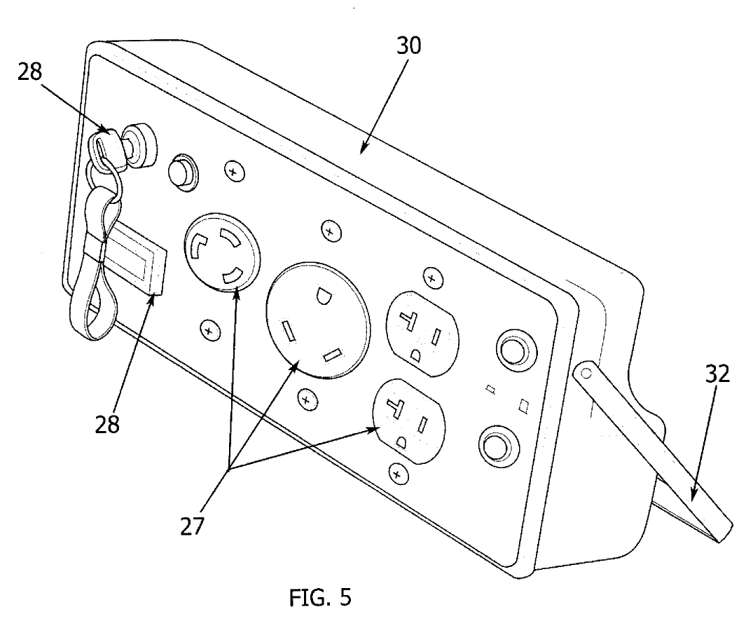

Referring now to FIG. 5, the detachable panel 30 is shown detached from the portable generator 10. The detachable panel 30 includes a handle 32 pivotally coupled to the detachable panel 30 for supporting the detachable panel 30 in an upright position. The handle 32 may also be gripped for carrying the detachable panel 30 from one location to another. In another embodiment, the detachable panel 30 may include a retractable leg. The retractable leg is configured to provide the detachable panel 30 support for upright positioning when the detachable panel 30 detached from the portable generator 30. The leg is retractable such that when the detachable panel 30 is securely coupled to the portable generator 10 the leg does not protrude outwardly. In other words, the retractable leg is stowed away for conveniently securing the detachable panel 30 to the portable generator 10.

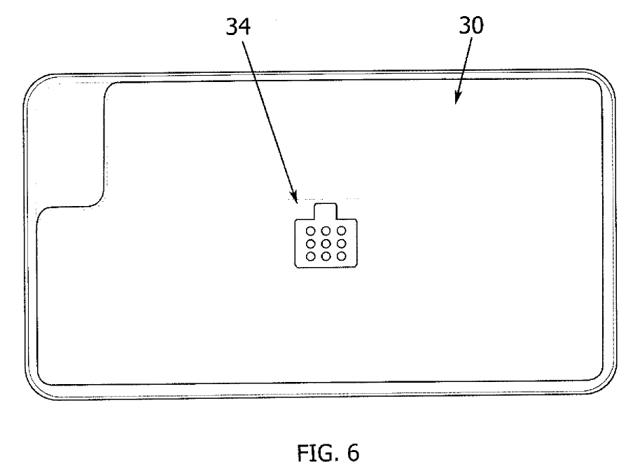

Referring to FIG. 6, the second electrical connector 34 is provided. The second electrical connector 34 is coupled to the detachable panel 30. The second electrical connector 34 may be a multi-pin quick connect connector. The second electrical connector 34 is configured to receive the interconnecting cord 16 for receiving current generated at the portable generator 10 or to receive the connector 20 from the cable 14. The connections with the cable 14 and 16 are weatherproof connections which prevent water from penetrating the connection to short out the connection. When the second electrical connector 34 of the detachable panel 30 receives the interconnecting cord 16 the detachable panel 30 is detached from the portable generator 10. When the detachable panel 30 is connected to the first electrical connector 14 via the second electrical connector 34, the detachable panel 30 is coupled to the portable generator 10. In one embodiment, the detachable panel 30 is enclosed in a freestanding compartment. The freestanding compartment may be used to store the interconnecting cord 16 when the interconnecting cord 16 is not in use.

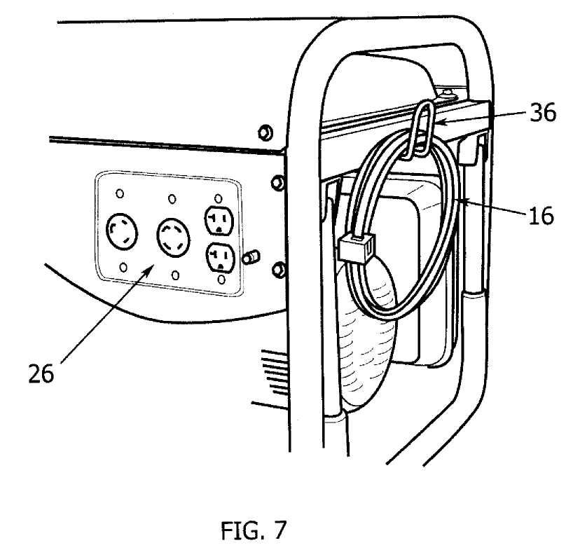

Referring now to FIG. 7, the portable generator 10 may be provided with a hook or rack 36 for storing the interconnecting cord 16 thereon. The interconnecting cord 16 may be used to quickly connect the first electrical connector 14 of the portable generator 10 to the second electrical connector 34 of the detachable power panel 26 when detached from the portable generator 10. The construction of the pigtail 14 and the interconnecting cord 16 will vary depending on whether the panel 12 or 26 has outlets 27, control functions 28 or displays 29. To transmit 120V power only the interconnecting cord 16 uses three wires, one hot, one ground and one neutral. For 220V an additional hot wire is added. Depending on the amperage of the power outlets or outlets 27, additional hot wires may be needed. Typically, each pin in the multi-pin connector 17a, 17b, 20, and 34 is associated with a single wire in the interconnecting cord 16 or the cable 14 or the panel 16, 26. Known circuitry can be provided at the panel 12, 26 to monitor the hot wire(s) at the panel in order to display voltage, Hertz, time/hours (based on hertz), current, but the basic information for such panel displays is provided by and transmitted by the hot wire. An additional wire is added for a low oil indicator or a low fuel indicator, with the indicator typically comprising a red light. At least one additional wire is typically provided for each engine control function since the engine ignition switch typically includes a ground for the ignition system and a fused wire to the cranking solenoid or starting motor. An additional dedicated wire is preferably used for engine shut off, typically to ground the ignition. The ignition can be by a switch, or by a button, and the number of wires in the cable 14 or cord 16 can vary.

The electrical signal from control(s) 28 on the panel 12, 26 affects the engine operation, primarily the engine speed. The electrical signal from control 28 starts the engine from 0 RPM, or stops the engine when it is running at operational speed, or causes the engine to idle when it was either stopped or at operational speed.

A single circuit breaker and reset switch can be provided on the panel 12, 26, or a separate circuit breaker and separate reset switch can be associated with each outlet; in either case such reset switches are in the prior art and breakers and resets in the panels 12, 26 do require a separate wire. Advantageously, any outlets 27 on the detachable panel 12, 26 have an associated circuit breaker and reset switch within the panel. The pigtail 14 and its connector 20 provide the selected power, control and monitoring signals to the detachable panel 12, 26.

It is believed that the prior art includes extension cords having an end with multiple power outlets associated with at least one circuit breaker at the power outlet end of the extension cord. The circuit breakers can thus be reset at the end of the extension cord. The wiring in the pigtail 14 and interconnecting cord 16 are different from these prior art extension cords by having at least one additional wire to transmit an electrical signal relating to the generator power, control or monitoring, and preferably relating to the generator control or monitoring not involving circuit breakers. For completeness of disclosure the present application discloses circuit breakers and reset signals as part of the control signals transmitted by the pigtail 14 and interconnecting cord 16, but for purposes of claiming the claims are not to be construed to encompass the prior art extension cables with circuit breaker reset functions or GFCI functions and references to the control signals or displays or wires for control signals or displays or indicators are not to be construed to include circuit breakers or resets for circuit breakers or GFCI signals or wires.

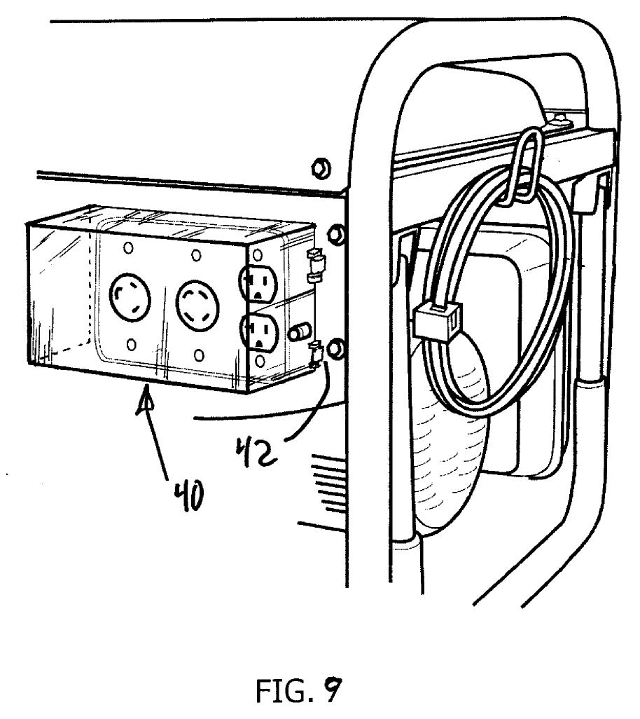

Referring to FIG. 9, a weather shield 40 may be optionally connected to the generator 10. As illustrated, the weather shield 40 is a transparent shield with hinges 42 at the side (or top) and with a latch (not shown) opposite the hinge. The weather shield 40 is open at the bottom so electrical cords can connect to the generator 10 with the shield in place. The weather shield 40 extends over the various controls and outlets to shield them from driving rain. The weather shield is sufficiently movable that the detachable power panel can be removed. In the depicted embodiment, the movable weather shield 40 is hinged at one side and opens to that hinged side to allow removal and reinsertion of the power panel 26. When the power panel 26 is attached to the generator 10, electrical cords enter the open bottom of the weather shield 40 to plug into the electrical outlets. The weather shield is advantageously configured to cover all controls and outlets on the generator, even when the power panel 26 does not contain all the controls 28 and outlets 27, and is thus usable with the various embodiments of this invention. The weather shield 40 may be hinged to the detachable power panel 26 rather than to the generator 10.

The above description is given by way of example, and not limitation. Given the above disclosure, one skilled in the art could devise variations that are within the scope and spirit of the invention disclosed herein, including various ways of embodying a portable generator with a detachable control panel. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A portable generator having an internal combustion engine to power a device that generates electrical power, the portable generator having a wiring harness connected to the engine and generator, comprising:
a first pigtail cable connected to the portable generator wiring harness with a first multi-pin connector on the pigtail cable;
a detachable panel having at least one electrical outlet and a second multi-pin connector configured to mate with the first connector; the second multi-pin connector providing power to the at least one electrical outlet and further providing a control signal from the detachable panel to the generator which can affect the operation of the generator.

2. The portable generator of claim 1, wherein the detachable panel is mounted on the portable generator.

3. The portable generator of claim 1, further comprising an intervening cord having a third multi-pin connector at a first end configured to mate with the first connector and having a fourth multi-pin connector and second end configured to mate with the second connector, the intervening cord transmitting any electrical signals and power from the first connector to the detachable panel.

4. The portable generator of claim 1, wherein the control signal includes an electrical signal affecting at least one of the engine on, engine off, engine start, or engine idle.

5. The portable generator of claim 1, wherein the detachable panel contains a display for at least one of the Hertz, amperage, voltage or hours of operation associated with at least one outlet, and wherein the panel further contains circuitry for monitoring the electrical parameters associated with at least one pin to determine an electrical signal activating the display.

6. The portable generator of claim 1, wherein the detachable panel contains an indicator light for indicating the generator is low on at least one of fuel or oil and wherein a signal activating the indicator is transmitted by an electrical signal associated with a pin of the second multi-pin connector.

7. The portable generator of claim 1, wherein the generator has a receptacle into which the detachable panel is removably inserted, with a latch to hold the panel to the generator.

8. The portable generator of claim 7, wherein the generator has a movable cover located to shield the detachable panel from rain when the detachable panel is placed in the receptacle.

9. The portable generator of claim 1, wherein the multi-pin connectors are each 9-pin, waterproof connectors.

10. An interconnecting cord for use with a portable generator having an internal combustion engine to power a device that generates electrical power, the portable generator having a wiring harness connected to the engine and generator and ending in a first multi-pin connector having at least one pin in electrical communication with the engine or starter to provide a signal effecting the starting, stopping or idle of the engine, the cord comprising:
a multi-wire electrical cord having multi-pin connectors at each end with one of the electrical cord connectors configured to mate with the multi-pin connector on the portable generator, the cord having at least one hot wire, a ground wire, a neutral wire each connected to a separate pin on the cord's multi-pin connectors, the cord having an additional wire connected to a pin on the cord's multi-pin connectors which pin is located to mate with the at least one pin on the generator's connector that is in electrical communication with the engine or starter.

11. The cord of claim 10, wherein the multi-pin connectors are waterproof connectors.

12. A detachable panel for use with a portable generator having an internal combustion engine to power a device that generates electrical power, the portable generator having a wiring harness connected to the engine and generator with a multi-pin connector connected to the wiring harness, the detachable panel comprising:
a housing having a front and back and enclosing wires and at least one circuit breaker in electrical communication with at least one electrical outlet on the housing and in further electrical communication with a multi-pin connector configured to mate with the multi-pin connector of the portable generator to provide electrical power to the outlet;
at least one of an engine control device or a generator monitoring device connected to the housing, the engine control device configured to send an electrical signal through a pin in the panel's multi-pin connector to alter the engine speed, and the generator monitoring device comprising circuitry in the panel configured to monitor at least one pin of the panel's multi-pin connector to determine and display a signal representative of the voltage, amperage or Hertz associated with that pin.

13. The detachable panel of claim 12, wherein the panel has an engine control device and no engine control device.

14. The detachable panel of claim 12, wherein the panel has at least one display and no engine control device.

15. The detachable panel of claim 12, wherein the panel's multi-pin connector is located on the back of the panel.

16. The detachable panel of claim 12, wherein the generator has a shaped recess and the housing is configured to fit into that recess in the generator.

17. The detachable panel of claim 12, wherein the housing has an indicator indicating that the generator is low on at least one of fuel or oil and wherein a signal activating the indicator is obtained from a pin on the panel's multi-pin connector.

18. The detachable panel of claim 12, wherein the generator has a receptacle into which the detachable panel is removably inserted, with a latch to hold the panel to the generator.

19. The portable generator of claim 1, further comprising a movable support member for supporting the panel in a desired position on the ground.

20. The detachable panel of claim 12, further comprising a movable support member for supporting the panel in a desired position on the ground.

21. The portable generator of claim 1, wherein the detachable panel is mounted on the portable generator.

22. A method for connecting a detachable panel to a portable generator having an internal combustion engine to power a device that generates electrical power, the portable generator having a wiring harness connected to the engine and generator and ending in a first multi-pin connector having at least one pin in electrical communication with the engine or starter to provide a signal effecting the starting, stopping or idle of the engine, the method comprising:
connecting a second multi-pin connector of the detachable panel with the first multi-pin connector of the portable generator;
transmitting an electrical signal through at least one pin in the detachable panel's multi-pin connector to alter the engine speed, and the generator monitoring device comprising circuitry in the detachable panel configured to monitor at least one pin of the detachable panel's multi-pin connector to determine and display a signal representative of the voltage, amperage, or Hertz associated with that pin; and
providing power to at least one electrical outlet on the detachable panel.

23. The method of claim 22, wherein the detachable panel is mounted on the portable generator.

24. The method of claim 22, further comprising:
connecting a third multi-pin connector of an intervening cord with the first connector;
connecting a fourth multi-pin connector of the intervening cord with the second connector; and
transmitting any electrical signals and power from the first connector to the detachable panel.

25. The method of claim 22, wherein the detachable panel contains a display for at least one of the Hertz, amperage, voltage or hours of operation associated with at least one outlet, and wherein the detachable panel further contains circuitry for monitoring the electrical parameters associated with at least one pin to determine an electrical signal activating the display.

26. The method of claim 22, wherein the detachable panel contains an indicator light for indicating the generator is low on at least one of fuel or oil and wherein a signal activating the indicator is transmitted by an electrical signal associated with a pin of the second multi-pin connector.

27. The method of claim 22, wherein the multi-pin connectors are each 9-pin, waterproof connectors.

28. The method of claim 22, wherein the detachable panel includes a housing having a front and back and enclosing wires and at least one circuit breaker in electrical communication with at least one electrical outlet on the housing.

29. A generator having an internal combustion engine to power an armature that generates electrical power, the generator having a plurality of armature windings connected to the engine and generator, comprising:
a first pigtail cable in electrical communication with the plurality of armature windings, the first pigtail cable having a first multi-pin connector;
a detachable panel having at least one electrical outlet and a second multi-pin connector configured to mate with the first connector; the second multi-pin connector providing power to the at least one electrical outlet and further providing a control signal from the detachable panel to the generator which can affect the operation of the generator; and
an interconnecting cord having a third multi-pin connector configured to mate with the first connector and a fourth multi-pin connector configured to mate with the second multi-pin connector, the interconnecting cord providing an electrical circuit path between the generator and the detachable panel.
